(19) United States
(12) Patent Application Publication
(10) Pub. No.: US 2014/0023853 A1
(43) Pub. Date: Jan. 23, 2014

(54) PARTICLE OF A PHASE CHANGE MATERIAL WITH COATING LAYER

(71) Applicants: Vincent Gueret, Hangzhou (CN); Christian Monereau, Montpellier (FR); Pluton Pullumbi, Versailles (FR)

(72) Inventors: Vincent Gueret, Hangzhou (CN); Christian Monereau, Montpellier (FR); Pluton Pullumbi, Versailles (FR)

(73) Assignee: L'Air Liquide Societe Annonyyme pour I'Exploitatio des Proccedes Georges Claude, PAris (FR)

(21) Appl. No.: 14/009,799

(22) PCT Filed: Mar. 13, 2012
(86) PCT No.: PCT/FR12/50514

§ 371 Date: Oct. 4, 2013

(30) Foreign Application Priority Data
Apr. 8, 2011 (FR) 1153057

(51) Int. Cl. C09K 5/06

(52) U.S. Cl. CPC C09K 5/06
USPC 428/323

(57) ABSTRACT

PCM particle consisting of an agglomerate comprising a phase change material (PCM) and a coating layer with a composition different from that of the agglomerate.

### CROSS REFERENCE TO RELATED APPLICATIONS

This application is a §371 of International PCT Application PCT/FR2012/050514, filed Mar. 13, 2012, which claims the benefit of FR 1153057, filed Apr. 8, 2011, both of which are herein incorporated by reference in their entireties.

### TECHNICAL FIELD OF THE INVENTION

The invention concerns the modification of the physical characteristics of the particles of a phase-change material (PCM) by coating of said particles, the mixing of such a coat of material with at least one adsorbent material, and the adsorption unit using such a mixture.

### SUMMARY OF THE INVENTION

Any cyclic method during which certain steps are exothermic, that is to say accompanied by a release of heat, whereas certain other steps are endothermic, that is to say accompanied by a consumption of heat, is referred to as a “thermocyclic method”. Typical examples of thermocyclic methods according to the present invention include methods for gas separation by pressure-modulated adsorption, and any method using a chemical conversion coupled to pressure-modulated adsorption cycles, as mentioned above, make it possible to displace the equilibrium of the chemical reactions.

In the context of the present invention, any method for gas separation by pressure-modulated adsorption, using a cyclic variation of the pressure between a high pressure referred to as the adsorption pressure and a low pressure referred to as the regeneration pressure, is, unless otherwise stipulated, referred by the term “PSA method”. Consequently the generic term PSA method is employed indifferently for designating the following cyclic methods:
VSA methods in which the adsorption takes place substantially at atmospheric pressure, referred to as “high pressure”, that is to say between 1 bara and 1.6 bara (bara=bar absolute), preferentially between 1.1 and 1.5 bara, and the desorption pressure, referred to as “low pressure”, is less than atmospheric pressure, typically between 30 and 800 mbara, preferably between 100 and 600 mbara;
VPSA or MPSA methods in which the adsorption takes place at a high pressure substantially higher than atmospheric pressure, generally between 1.6 and 8 bara, preferentially between 2 and 6 bara, and the low pressure is below atmospheric pressure, typically between 30 and 800 mbara, preferably between 100 and 600 mbara;
PSA methods in which the adsorption takes place at a high pressure appreciably higher than atmospheric pressure, typically between 1.6 and 50 bara, preferentially between 2 and 35 bara, and the low pressure is higher than or substantially equal to atmospheric pressure and therefore between 1 and 9 bara, preferably between 1.2 and 2.5 bara.

Hereinafter the term “RPSA method” will be used to designate PSA methods with a very rapid cycle, in general less than 1 minute.

In general terms, a PSA method makes it possible to separate one or more gas molecules from a gaseous mixture containing them, by exploiting the difference in affinity of a given adsorbent or, where applicable, of several adsorbents for these various gas molecules.

The affinity of an adsorbent for a gaseous molecule depends on the structure and composition of the adsorbent, as well the properties of the molecule, in particular its size, electron structure and multipole moments.

An adsorbent may for example be a zeolite, an active carbon, an activated alumina, a silica gel, a carbonaceous or otherwise molecular sieve, a metallo-organic structure, one or more oxides or hydroxides of alkali or alkaline-earth metals, or a porous structure containing a substance capable of reacting reversibly with one or more gas molecules, such as amines, physical solvents, metal complexing agents, or metal oxides or hydroxides for example.

Adsorption is an exothermic phenomenon, each molecule-adsorbent pair being characterised by an adsorption enthalpy (isosteric heat) or a reaction enthalpy in general. Symmetrically, desorption is endothermic.

Moreover, a PSA method is a cyclic method comprising several sequential adsorption and desorption steps.

Consequently some steps in the cycle of a PSA are exothermic, in particular the step of adsorption of the gas molecules adsorbed on the adsorbent, whereas other steps are endothermic, in particular the step of regeneration or desorption of the molecules adsorbed on the adsorbent.

The thermal effects that result from the adsorption enthalpy or the reaction enthalpy lead, in general terms, to the propagation, at each cycle, of a heat wave on adsorption limiting the adsorption capacities and a cold wave on desorption limiting desorption.

This local cyclic phenomenon of temperatures changes has not insignificant impact on the separation performances of the method, such as productivity, separation efficiency and the specific separation energy, as stated by the document EP-A-1188470.

Thus it has been shown that, if the thermal changes due to adsorption enthalpy were completely eradicated, the productivity of certain current industrial O₂ PSAs would be improved by around 50% and the oxygen yield would be improved by 10%. Likewise, for other types of PSA, attenuating the thermal changes would give rise to an appreciable improvement in the separation performances.

This negative phenomenon having been identified, several solutions have already been described for attempting to decrease or eliminate it.

Thus it has been proposed to increase the heat capacity of the adsorbent medium by adding an inert binder, when the particles are manufactured, by depositing the adsorbent medium on an inert core, by adding particles that are identical to the adsorbent but inert. For example, in the case of an O₂ PSA method, effecting the adsorption of the nitrogen contained in air on a composite bed consisting of 5A and 3A zeolites differentiated from each other only by the size of their pores has already been tested: only those of 5A zeolite enable nitrogen to be adsorbed since those of 3A zeolite are too small.

Moreover, the use of external heating and/or cooling means for counterbalancing the thermal effects of the desorption or adsorption, such as the use of heat exchangers, has also been described.

Thermal couplings between adsorption phase and regeneration phase have also been proposed, the adsorbent being disposed in the successive passages of a plate exchanger, the circulation of fluids then being organised so that the passages are alternatively in adsorption phase and desorption phase.

### BACKGROUND

Another solution for reducing the amplitude of the thermal changes consists of adding to the adsorbent bed a phase-change material (PCM), as described by the document U.S. Pat. No. 4,971,605. In this way, the adsorption and desorption heat, or some of this heat, is absorbed in the form of latent heat by the PCM, at the temperature, or in the range of temperatures, of the phase change of the PCM. It is then possible to operate the PCA unit in a mode closer to isothermal conditions.

In practice, phase change materials (PCMs) act as heat sinks at their phase-change temperature, or over their phase-change temperature range lying between a lower and higher phase-change temperature.

In order to be able to handle them, whether they be in the solid or liquid state, PCMs are in practice generally microencapsulated in a micronic solid shell, preferably based on polymers (melamine formaldehyde, acrylic, etc.).

Microencapsulated PCMs, available in powder form, cannot be introduced as they stand into an adsorbent bed since they would be entrained by the gas flows circulating in the adsorber.

The document WO 2008/037904 describes a method of the PSA type using a bed comprising adsorbent particles and particles of a phase-change material (PCM) in the form of agglomerates with a density different from that of the adsorbent but complying with the stability criteria of the mixture based on the ratio on the one hand of the densities and on the other hand of the diameters of the PCM agglomerates and the adsorbent particles in the composite bed.

One of the solutions that appears to be necessary for improving the thermics of PSA units and consequently their performances is therefore to produce mixtures of adsorbent and agglomerate of PCM with relatively close size and density in order to avoid or limit the problems of segregation.

However, one problem that is posed is providing a mixture of adsorbent and PCM particles preserving physical properties and in particular mechanical properties compatible with industrial use in various types of adsorbers such as for example cylindrical adsorbers with a vertical or horizontal axis, or radial adsorbers; and for the various applications envisaged.

This is because, in particular, in order to avoid problems of the creation of dust, particle debris, local settling, etc., the mixture must have sufficient characteristics in terms of resistance to crushing, resistance to attrition and elasticity.

For the adsorbent itself, these properties generally form part of the particular specifications defining its physical characteristics.

A resistance to crushing value and a value characteristic of the resistance to erosion by friction are typically found. The corresponding test methods are either standardised or particular to each supplier.

For example, resistance to crushing may be measured ball by ball or in a bed. The number of balls, the prior sieving of the balls, their residual water content, the way of increasing the pressure applied—for example the speed—must be defined in order to have reliable and repeatable measurements.

Resistance to attrition generally consists of measuring the percentage by weight of dust created after having subjected a certain quantity of adsorbent to a clearly defined treatment. There also, all the parameters must be defined in order to obtain useful measurements.

It is not necessary here to go into any detail in all the existing procedures for measuring certain mechanical properties or to list the values of these properties for all adsorbents but just to show that these mechanical properties form part of the basic characteristics of the adsorbents and that minimum values (for example resistance to crushing) or maximum values (for example creation of dust by attrition) are required for using the adsorbents effectively and safely.

It is therefore necessary to produce MCP particles having mechanical properties at a minimum close to those of the adsorbents so that these particles are not the weak link in the mixture by breaking or eroding.

It should be noted that, in the context of the present invention, the “diameter” means the equivalent diameter of the PCA particle. The “equivalent diameter” of a particle is that of the sphere having the same specific surface, this specific surface being the surface compared with the volume of the particle in question.

Thus, for a rod of diameter d and length l, the equivalent diameter De is obtained such that: De=6.1.d/(2.d+4.1)

For a pellet such that d=1, the equivalent diameter is the diameter of the particle. In general terms, for the majority of geometries of the particles used of a cylindrical type, an equivalent diameter is found lying between 0.75 and 1.3 times the diameter of the cylinder.

For a spheroid ball, the equivalent diameter is directly the diameter of the ball. For a population of balls that are essentially spherical but the diameters of which have a dispersion inherent in the industrial manufacturing method, a conventional definition is adopted: the equivalent diameter of a population of balls is the diameter of identical balls which, for the same bed volume, would give the same total surface area. This is because, as soon as the diameter distribution has determined (that is to say the various fractions Xi of diameter Di have been determined, with preferably i greater than or equal to 5 in order to obtain sufficient precision, for example by sieving or from image processing apparatus), the equivalent diameter is obtained by the formula: 1/De=Σi(Xi/Di)

For crushed adsorbents, a form in which some activated carbons can in particular be found, the particles are assimilated to spheres, the diameter distribution of which is determined by sieving, and then the above calculation formula is applied.

One solution of the invention is a PCM particle consisting of an agglomerate comprising a phase change material (PCM) and a coating layer with a composition different to that of the agglomerate.

Thus the solution consists only of modifying the surface of the agglomerate in order to increase the mechanical properties thereof, that is to say modify the composition or distribution of the constituents used during the formation of the particle a little before obtaining the required size. In this way the agglomerate is coated with a layer having different mechanical properties improving overall the mechanical strength of the PCM particle: resistance to crushing, attrition, and elasticity.

It appears that this coating could also have other beneficial functions such as improving the impermeability to fluid of the particle, which can be made non-porous, resistance to chemical attacks, heat transfer, etc.

It should be noted that this coating method is not applicable to the adsorbent since, in its case, the transfer of the molecules of the fluid to the active sites of the adsorbent is preponderant and any additional resistance to this transfer would be prejudicial or even catastrophic if tending towards an impervious barrier.

Coating of the PCM particles can be envisaged here only because the adsorption functions (the particle of adsorbent) have been physically separated from the heat-sink function (the PCM particle).

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

FIG. 1 shows an embodiment of the present invention.

FIG. 2 shows an embodiment of the present invention.

FIG. 3 shows an embodiment of the present invention.

FIG. 4 shows an embodiment of the present invention.

FIG. 5.a shows an embodiment of the present invention.

FIG. 5.b shows an embodiment of the present invention.

FIG. 6 shows an embodiment of the present invention.

FIG. 7.a shows an embodiment of the present invention.

FIG. 7.b shows an embodiment of the present invention.

FIG. 8 shows an embodiment of the present invention.

### DETAILED DESCRIPTION

FIG. 1 shows a PCM particle 1 according to the invention consisting of an agglomerate of microcapsules of PCM 2—optionally agglomerated by a binder 3—and coated with a coating layer 4.

One advantage procured by a coating layer is that, in the event of accidental release of microcapsules of PCM from the aggregate, they are retained inside the coating layer and there is no risk of their being swept away by the fluid.

In extreme cases, this makes it possible to limit the quantity of binder to the minimum in order to ensure cohesion of the agglomerate during manufacture thereof, thus making it possible to obtain a particle very rich in PCM and therefore with a high thermal performance. The mechanical properties, in particular of resistance to attrition, are then essentially due to the presence of the coating layer which in this case has the role of a shell.

According to circumstances, the PCM particle according to the invention may have one or more of the following features:
the thickness of the coating layer represents between 0.001% and 10% of the diameter of the particle, preferably between 0.01% and 1% of the diameter of the particle; it should be noted that the thickness of the coating is a compromise between the amplitude of the modifications of the mechanical or thermal properties that are sought and the useful volume of microcapsules of PCM, that is to say in practice the volume quantity of heat available during the phase change. The thickness will also depend on the deposition method used. The nature of the deposition may be varied. It will depend essentially on the improvements that are sought;
the coating layer comprises an organic or inorganic material; an organic coating will for example improve the resistance to attrition and the elasticity whereas an inorganic coating will promote thermal conduction and hardness;
the organic or inorganic material content is greater than the organic or inorganic material content of the agglomerate.
the organic material is at least one polymer; the volume percentage of the at least one polymer in the coating layer is preferentially greater than 50% and may be as much as 100%. A coating layer completely made from polymer may make the PCM particle completely gastight and in doing this tend to improve the performances of the adsorption unit that would use such PCM particles (by reducing the gaseous volume in the bed of adsorbent/PCM). The polymer is preferably polyurethane and/or polycarbonate. These polymers constitute in fact one of the basic solutions for producing the envelope and more particularly polyurethane because of its low cost and its physical properties;
the coating layer comprises solid particles with thermal conductivity greater than 0.5 W/m/K; the coating layer preferably comprises by volume between 0% and 50% solid particles, more preferentially between 0% and 15% solid particles;
the coating layer comprises at least 0.5% polymer and is impervious;
the inorganic material is a metal compound, a metal or a metal alloy; nitrides, oxides or metal carbides, or metal alloys as well as pure metals, can be used. A ferromagnetic character different from that of the adsorbent particles may allow magnetic separation of the PCM particles and the adsorbent;
the proportion of phase change material in the coating layer is less than the proportion of phase change material in the agglomerate;
the coating layer comprises graphite rods;
the phase change material is chosen from paraffin, fatty acids, hydrogenous compounds, oxygenated compounds, phenyls and hydrated salts or a mixture of these compounds.

It should be noted that, unless otherwise stipulated, when the diameter of a population of particles (PCM agglomerates, adsorbent) are mentioned, this means the “mean equivalent diameter”.

The thickness of the coating layer obviously varies locally for a given particle but also from particle to particle.

The thickness of the layer means the mean thickness that can be measured from a sample of particles open in their centre. FIG. 8 shows a sample of four half-balls corresponding to a random sample of four particles.

The ratio can be defined as the mean of the eight thicknesses EP measured along the axis AA to the mean of the four diameters D measured along the axis.

If it is sought to define this ratio more precisely, a larger number of particles (say 25) can be used.

In practice, in order to define the mean thickness of the protective layer, the diameter of a sample of non-coated agglomerates and the diameter of a second sample of the same coated population (same manufacturer) are measured. The difference in the diameters easily gives the thickness of the coating.

Note that the heat absorption capacity of a PCM is all the greater, the higher its latent heat. Generally PCMs are used for their solid-liquid phase change.

In order to be able to handle them, whether they be in the solid or liquid state, PCMs are in practice generally microencapsulated in a micronic solid shell, preferably based on polymers (melamine formaldehyde, acrylic, etc.).

Since paraffins are in particular relatively easy to microencapsulate, they are generally PCMs of choice compared with hydrated salts, even if paraffins have a latent heat generally less than that of hydrated salts.

In addition, paraffins have other advantages such as reversibility of phase change, chemical stability, defined phase change temperature or defined lower and upper phase change temperatures (that is to say there is no hysteresis effect), low cost, low toxicity and wide choice of phase change temperatures according to the number of carbon atoms and the structure of the molecule.

Microencapsulated paraffinic PCMs are in the form of a powder, each microcapsule constituting this power having a diameter of between 50 nm and 100 μm, preferentially between 0.2 and 50 μm. Each microcapsule has a thermal conductivity of around 0.1 to 0.2 W/m/K, depending on whether the paraffin is in the solid or liquid state inside the microcapsule.

Microencapsulated PCMs available in powder form cannot be introduced into an adsorbent bed as they stand since they would be entrained by the gas flow circulating in the adsorber.

In the context of the invention, these microcapsules are therefore agglomerated. Microcapsule agglomerate means a solid with a dimension greater than 0.1 mm manufactured according to one of the known powder agglomeration techniques (granulation, extrusion, atomisation, fluidised bed, etc.) and able to adopt various forms, in particular the form of a ball, an extrusion, a pellet, a crushed piece obtained by crushing and sieving blocks of larger dimensions, or plate obtained by cutting previously compacted sheets, or others.

The agglomerate of PCM microcapsules is formed by a wet granulation method in a fluidised bed (spray coating) or by an extrusion method optionally followed by shaping in a fluidised bed granulation method.

The wet granulation method in a fluidised bed (spray coating) consists of the gradual coating of microcapsules by spraying a suspension containing these PCMs according to the so-called spray coating technique, on the agglomerates being formed and advantageously simultaneously dried. The particles are maintained in suspension in a hot air current while the coating suspension composed of a solvent (preferably water and PCM the concentration of which in said suspension various between 10% and 50% by weight as well as binders and if necessary surfactants) is sprayed. Passing through the coating cycle on several occasions covers the surface of the particles uniformly. The temperature and air flow as well as the spraying rate and pressure are chosen so as to form a homogeneous layer and to avoid the formation of scales. In this way a population of spheroid particles of essentially identical diameter is obtained.

Another method well suited to the agglomeration of PCM microcapsules is agglomeration by extrusion. Extrusion is a (thermo)mechanical fabrication/agglomeration method by means of which the material in powder form is compressed (mixed or not with suitable binders) and forced to pass through a die having the cross section of the agglomerated objects to be obtained. Extrusion is applied in various branches of industry, with materials such as metals, plastic materials, rubbers, composite materials, adsorbents, clay for manufacturing honeycomb bricks, and food pastes.

It is these particles obtained by these two methods or other methods enabling the agglomeration of PCM microcapsules into PCM agglomerate particles that are then coated with a final coating improving their physical properties. This coating may be performed:
either by a liquid (or wet) method in which the components of said coating are brought in the form of a solution, emulsion or dispersion containing the solvent (preferably water) as well as the compounds necessary for forming the coating, which can be obtained by polymerisation or copolymerisation or crosslinking under the effect of one or more factors among the following: increase in temperature, increase in their concentration, generation of free radicals or by chemical reaction on the surface. A dipping, spraying, coating, etc. method is spoken of:
either by a so-called dry method where the components of said coating are brought in the form of molecules in gaseous phase such as for example PVD (physical vapour deposition) or CVD (chemical vapour deposition) methods.

The methods where the coating is carried out wet can be performed
either in a fluidised bed (the deposition of a thin layer is effected by atomisation and drying of a solution on the surface of each PCM particle),
or by a chemical deposition method such as for example galvanic coating.

The methods in which the coating is carried out dry are generally performed either in a fluidised bed, or in a vacuum, or in a rotary chamber for moving PCM extrusions or particles.

In the case of coatings carried out wet, in particular in a fluidised bed, the nature of the solution used to do this final coating will depend on the property or properties that it is wished to improve as well as the nature of the PCM agglomerate that serves as a support.

The main compound of the solution may be an aqueous dispersion of polymers chosen from the following classes of polymer:
an aqueous polyurethane dispersion (PUD) which comprises an aqueous medium with dispersed acrylic polyurethane particles, comprising a reactional product obtained by the polymerisation of a pre-emulsion formed from ethylenic unsaturation polymerisable hydrophobic monomers, a crosslinking monomer and an active prepolymer of hydrogenated acrylic polyurethane, which is a reaction product obtained by the reaction of a polyol, an ethylenic unsaturation polymerisable monomer containing at least one hydroxide group and optionally a carboxylic acid group, and a polyisocyanate. Aqueous polyurethane dispersions (PUDs), either as a single component or combined with other polymers, are being used more and more in the field of coatings (paints, surfacings, inks, varnishes etc.), in particular because of legislative pressures for reducing VOC (volatile organic compound) emissions, but also because they have excellent properties that are difficult to obtain with other polymers.

The main advantages of PUDs are a great variety in the macromolecular composition and therefore a wide choice of performance characteristics: good physical properties (elasticity, elongation at break, etc.), good resistance to impacts and abrasions; low minimum film formation and glass transition temperatures, which has the consequence of being able to reduce the level of coalescents and any addition of plasticisers. Good compatibility with pigments, even metallic, good adhesion to metals and plastics, and good compatibility with other polymers, in particular acrylic polymers, can also be noted.

PUDs are essentially linear polyurethanes/ureas of high molecular weight stabilised in water and spherical particles with a diameter of less than 1 μm. The dispersibility of polyurethane in water is facilitated by the presence of ionic functions in the polymer chains. The viscosity of PUDs is fairly low (50 to 500 mPa·s), and it is sometimes necessary to add a thickener in order to obtain the required rheological properties during the step of injection into the fluidised bed of PCM during the formation of film coating each PCM particle.

The proportion of dry matter may vary from 30% for rigid products to 50% for flexible products, or even 60% for coatings on textiles. Flexible polymers are generally solvent-free whereas rigid polymers contain polar cosolvents miscible with water (such as tetrahydrofuran, dimethyl formamide or N-methyl pyrrolidone) to assist the coalescence of the particles. The end products (polymers issuing from dispersions) may combine flexible or extremely flexible polymers (used in textiles) with rigid polymers resistant to abrasion and impacts used in the design of varnishes protecting wood, metal or plastic materials. In our case one of the properties sought was the improvement in the mechanical strength of the MCP particles and the PUDs were chosen so as to maximise this property. In addition, residual isocyanate groups being rapidly consumed in the aqueous medium, PUDs are much less dangerous than their equivalents based on solvent. Finally, unlike other polymers in aqueous dispersion used in printing applications, the products obtained from PUDs do not redissolve after drying in an aqueous or alkaline environment.
An aqueous dispersion of a polymer in the group of thermosetting resins formed by resins based on phenol, urea, melamine, xylene, diallylphthalate, epoxy, aniline, furan or polyurethane;
An aqueous dispersion of a polymer in the following group of resins consisting of polystyrene, polymethyl methacrylate, cellulose acetate, polyamide, polyester, polyacrylonitrile, polycarbonate, polyphenyleneoxide, polyketone, polysulphone or polyphenylenesulfide;
An aqueous dispersion of the group of thermoplastic elastomers consisting of elastomers of the styrene type such as styrene-butadiene-styrene block copolymers or styrene-isoprene-styrene block copolymers or the hydrogenated form thereof, elastomers of the PVC, urethane, polyester or polyamide type, thermoplastic elastomers of the polybutadiene type such as 1,2-polybutadiene or trans-1,4-polybutadiene resins; chlorinated polyethylenes;
An aqueous dispersion of a polymer from the group of water-soluble polymers consisting of cellulosic polymers, polyelectrolytes, ionic polymers, acrylate polymers, acrylic acid polymers, gum arabic, polyvinyl pyrrolidone, polyvinyl alcohol, polyacrylic acid, polymethacrylic acid, sodium polyacrylate, polyacrylamide, polyethylene oxide, polyethylene glycol, polyethylene formamide, polyhydroxyether, polyvinyl oxazolidinone, methyl cellulose, ethyl cellulose, carboxymethyl cellulose, ethylhydroxyethyl cellulose, sodium polyacrylate, copolymers thereof and mixtures thereof.

It may also be a case of a solution of oligomers of polymers in a crosslinking solvent. This approach represents a disadvantage related to the generation of large quantities of VOCs (volatile organic compounds) requiring a dedicated post-treatment to the flows coming out of the fluidised bed.

Moreover, the formation of the coating may be accelerated by photocrosslinking in situ during the formation of the coating in the fluidised bed. Crosslinking reinforced by UV irradiation is a polymerisation reaction, initiated by UV radiation, that, in a fraction of a second, transforms a coated liquid film applied to a substrate into a three-dimensional solid polymer material. The typical formulation of a photocrosslinkable resin contains three basic ingredients: a photoinitiator, a monomer and oligomer, the last two being provided with reactive chemical functions. Photocrosslinking under UV is a technique that uses UV light to start the crosslinking of a liquid formulation (or of a powder) and obtaining a dry, solid and well crosslinked coating. The use of coatings crosslinkable under UV in a fluidised bed is one of the techniques that makes it possible to obtain excellent coatings of MCP particles having high performance for a relatively thin layer. The crosslinking corresponds to the formation of one or more three-dimensional lattices, by chemical or physical method. The crosslinked structures are usually prepared from linear or branched prepolymers with a low molecular mass (resulting from partial polymerisation), crosslinked under the effect of heat in the presence of a catalyst/hardener.

Photopolymerisation offers, over conventional thermal methods, particularly interesting advantages:
polymerisation is almost instantaneous, the change from the molecule to the polymer material taking place in a few tenths of a second under intense irradiation; because of this it requires only a small expenditure of energy;
crosslinking occurs only in spatially well-defined areas, those that are exposed to light radiation, which makes it possible to produce images in relief at high resolution;
the reaction can be triggered at a precise instant even in the fluidised bed and be stopped at any moment, by virtue of time control of the irradiation;
the intensity of the light source can be modulated in a very wide range, which makes it possible to control the initiation speed;
by acting on the wavelength of the light radiation and/or on the photo initiator concentration, it is possible to adjust the depth of penetration of the light and therefore the thickness of the polymer layer formed, which may vary from a few micrometres to several millimetres;
the photoinitiated polymerisations are normally carried out at ambient temperature, with resins not containing any solvent, which reduces the emission of polluting vapours;
the polymer substances fabricated by this method have technical characteristics that compare very favourably with those of film polymerisation products or the use of aqueous dispersions and the characteristics obtained show good resistance to solvents and abrasion, an excellent surface quality, a very high degree of conversion and the absence of odour. Various crosslinking mechanisms are possible for initiating polymerisation.

The mechanism of crosslinking by radical initiation is particularly suited to acrylates, methacrylates, polyfumarates, unsaturated polyesters, polyvinyls, polycarbonates, vinyl ethers and urethanes. The mechanism of crosslinking by cationic initiation is suited to epoxy cycloaliphatics, carbohydrate ethers and epoxy/oxetane systems and vinyl ethers.

The hardness of the surface of a coating obtained by one of these wet deposition methods in a fluidised bed, measured by indentation techniques, may vary from approximately 10 N/mm² to 1000 N/mm² but it is however generally less than 500 N/mm².

As described above, this coating of the agglomerates of PCM microcapsules may be done by various coating methods: by liquid method or dry method: spraying, immersion, layering, putting in contact with vapours, in dedicated equipment (of the reactor type) or during transfer (moving belt, vibrating belt, etc.), but preferentially this coating will be carried out in a vertical fluidised bed, continuous or discontinuous.

Also preferentially, the coating step will done in the same device as the step of agglomeration of the PCM particles by modifying at the appropriate time the composition of the suspension injected into the reactor.

This is because, when the population of PCM agglomerates reaches the required dimensions (diameter), the injecting solution is modified in order to proceed with the coating step. This modification may consist of spraying only coating product without PCM microcapsules (or with a substantially lower proportion than during the previous agglomeration step, say less than 50% of the previous quantity, preferably less 10%).

It may consist of injecting a solution comprising one or more constituents different from those used previously.

Another subject matter of the present invention is a mixture of PCM particles according to the invention and adsorbent particles.

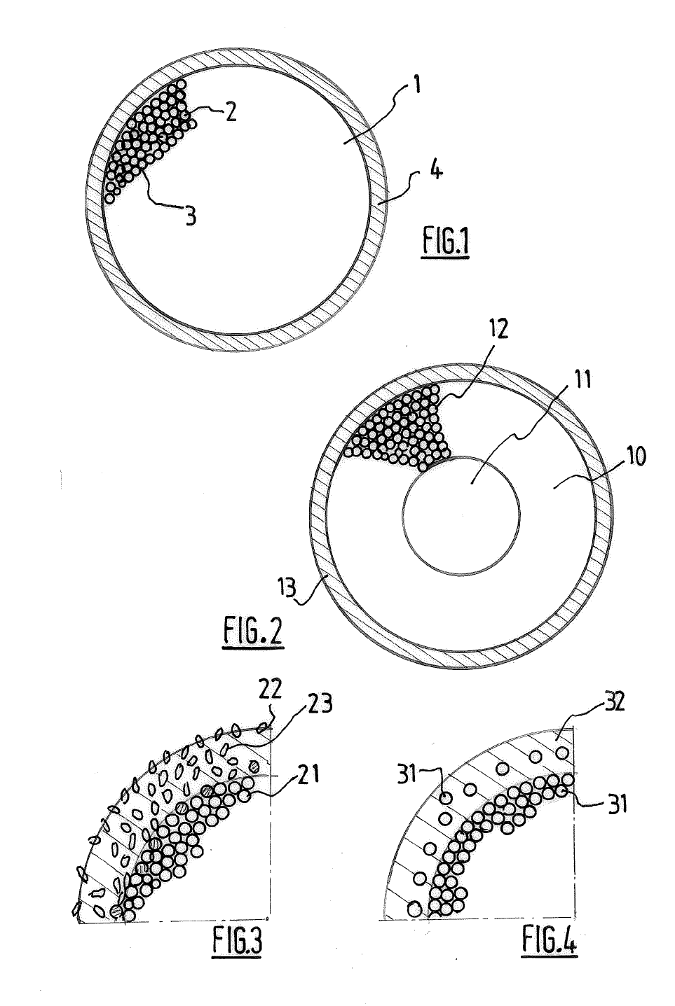

FIG. 2 shows a PCM particle manufactured according to this method and also comprising at the centre a core, for example an iron core.

The thickness of the coating layer 13 is small compared with the diameter of the particle 10 produced. In practice, the thickness of the coating will be from a few microns to a few tens of microns for particles with diameters generally between 0.5 and 5 millimetres.

The thickness to diameter ratio will range from approximately 5/5000 to 50 over 500 (in microns), that is to say from 0.1% to 10%.

FIGS. 3 to 6 show enlargements of the coating zone. FIG. 3 shows a coating 23 containing solid particles 22. These solid particles may be ferromagnetic to enable separation of PCM particles and adsorbent particles by magnetisation; they may be heat-conductive and improve the thermal transfer from the wall to the microcapsules 21; they may consist of kinds of fins on the surface of the particle in order to increase the heat transfer from the fluid to the PCMs. FIG. 4 shows the simplest coating 32. This layer may contain a certain number of PCM microcapsules still free at the start of coating. The coating of FIG. 4 may be fluidtight, in particular impervious to a gas so that the apparent porosity of the coated PCM particle may be almost zero, let us say statistically less than 5% for a bed having a large number of individuals.

The coating may actually make the agglomerate impervious to the fluid treated in the adsorber containing the adsorbent/PCM mixture.

This may directly increase the separation performances since the presence of gas in the bed of adsorbent (interstitial gas or in the macropores of the particles) has a negative effect. This is often the case in separations by PSA for example in H₂ PSA.

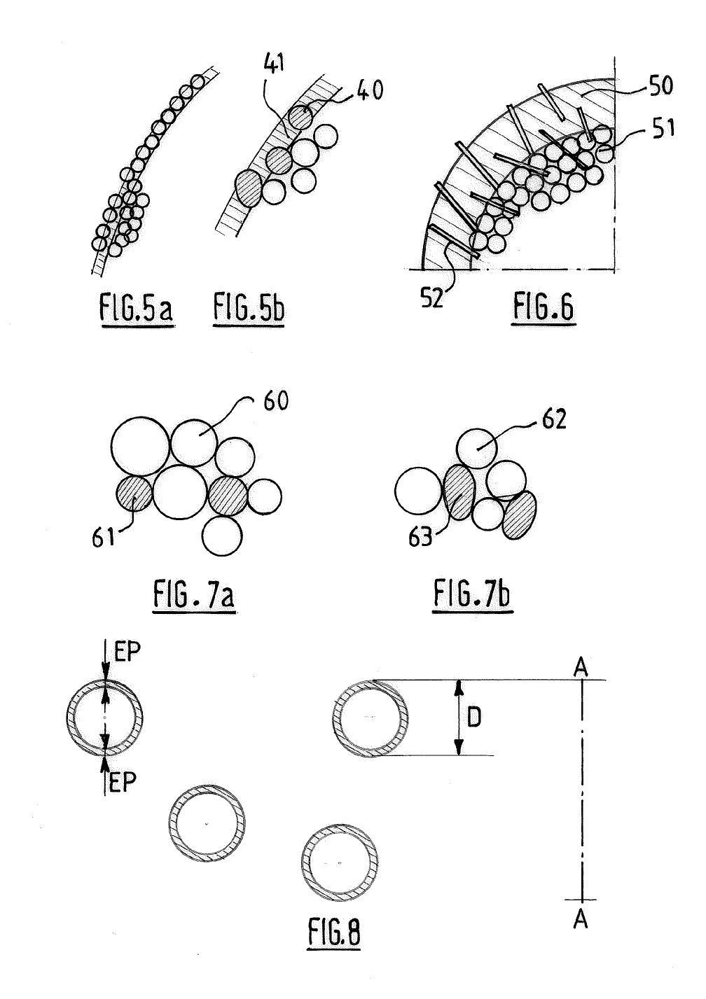

FIGS. 5.a and 5.b illustrate a very thin coating 41 the purpose of which is to reinforce the adhesion of the microcapsules 40 on the surface and to limit attrition.

FIG. 6 shows a coating 50 trapping graphite rods—or filaments—52 that may penetrate the internal PCM agglomerate 51 and/or emerge to the outside.

An additional advantage of such agglomerates coated with a thin film is that the particle, because of the lesser quantity of binder—or the possibility of using other types of binder—may be more elastic than the non-covered particle.

Elastic means here that, subject to a unidirectional pressure, the shape of the particle changes without there being destruction of said particle. An initially mainly spherical particle will thus adopt the form of an ellipsoid before breaking The contact at a singular point in the case of two rigid spheres will be able to extend in such case to a substantially greater surface area.

This possibility of deforming while keeping sufficient mechanical properties may be interesting from several points of view.

The adsorbent/PCM mixture also has greater elasticity, which results in reducing the forces between particles and between particles and wall of the adsorber during operations.

The ability of coated PCM particles to deform slightly while keeping their physical integrity also makes it possible to increase the contact surface area between the particles of adsorbent and the PCM particles, thus improving the direct heat transfer by adsorbent/PCM conduction. In this case, there is a “contact surface” between adsorbent and PCM instead of the simple “contact at a singular point” between balls that are supposed to be rigid.

FIGS. 7.a and 7.b illustrate respectively the contacts of the almost singular point type between adsorbent 60 and PCM 61 in the case of rigid particles and contacts involving a not insignificant surface area between rigid adsorbent 62 and relatively elastic PCM 63.

Another subject matter of the present invention is therefore also mixtures in any proportion of coated PCM particles and adsorbent such as activated alumina, silica gel, zeolite, MOF, exchanged or doped adsorbent, “grafted” adsorbent, that is to say to which a function such as an amine function is added, etc.

Another subject matter of the present invention is an adsorption unit comprising a fixed bed or movable bed in which a mixture according to the invention is used.

According to circumstances, the adsorption unit may have one or more of the following features:
the adsorption unit comprises a fixed bed and the proportion of PCM particles is substantially constant throughout the volume of the bed;
said unit is an H₂ PSA, a CO₂ PSA, an O₂ PSA or an N₂ PSA.

It should be noted that, if the adsorption unit comprises a fixed bed, this bed may comprise one or several layers of adsorbent normally referred to a multi-bed in technical language.

The invention therefore concerns the majority of PSA methods and more particularly non-limitatively, apart from H₂, O₂, N₂, CO and CO₂ PSAs, PSAs for defractionation of syngas into at least two fractions, PSAs on natural gas intended to remove nitrogen, and PSAs used for the fractionation of hydrocarbon mixtures.

The invention can also be implemented in a method:
argon PSA as described in particular in U.S. Pat. No. 6,544,318, U.S. Pat. No. 6,432,170, U.S. Pat. No. 5,395,427 or U.S. Pat. No. 6,527,831. Ar PSA makes it possible to produce oxygen at a purity greater than 93%, by preferentially adsorbing either argon or oxygen present in an O₂-rich stream issuing for example from an O₂ PSA. Ar PSAs generally use a carbonaceous molecular sieve or a silver-exchange zeolite (U.S. Pat. No. 6,432,170),
He PSA, which makes it possible to produce helium by preferentially adsorbing the other molecules present in the feed stream;
any PSA enabling separation between an alkene and an alkane, typically ethylene/ethane or propylene/propane PSAs for example. These separations are based on a difference in adsorption kinetics of the molecules on a molecular sieve, carbonaceous or otherwise;
any PSA for the fractionation of synthesis gas (syngas);
any PSA for separating CH₄ from N₂.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary a range is expressed, it is to be understood that another embodiment is from the one.

Optional or optionally means that the subsequently described event or circumstances may or may not occur. The description includes instances where the event or circumstance occurs and instances where it does not occur.

Ranges may be expressed herein as from about one particular value, and/or to about another particular value. When such particular value and/or to the other particular value, along with all combinations within said range.

All references identified herein are each hereby incorporated by reference into this application in their entireties, as well as for the specific information for which each is cited.

### Particle of a Phase-Change Material With Coating Layer

The invention concerns the modification of the physical characteristics of the particles of a phase-change material (PCM) by coating of said particles, the mixing of such a coat of material with at least one adsorbent material, and the adsorption unit using such a mixture.

Any cyclic method during which certain steps are exothermic, that is to say accompanied by a release of heat, whereas certain other steps are endothermic, that is to say accompanied by a consumption of heat, is referred to as a “thermocyclic method”.

Typical examples of thermocyclic methods according to the present invention include methods for gas separation by pressure-modulated adsorption, and any method using a chemical conversion coupled to pressure-modulated adsorption cycles, as mentioned above, make it possible to displace the equilibrium of the chemical reactions.

In the context of the present invention, any method for gas separation by pressure-modulated adsorption, using a cyclic variation of the pressure between a high pressure referred to as the adsorption pressure and a low pressure referred to as the regeneration pressure, is, unless otherwise stipulated, referred by the term “PSA method”. Consequently the generic term PSA method is employed indifferently for designating the following cyclic methods:
VSA methods in which the adsorption takes place substantially at atmospheric pressure, referred to as “high pressure”, that is to say between 1 bara and 1.6 bara (bara =bar absolute), preferentially between 1.1 and 1.5 bara, and the desorption pressure, referred to as “low pressure”, is less than atmospheric pressure, typically between 30 and 800 mbara, preferably between 100 and 600 mbara;
VPSA or MPSA methods in which the adsorption takes place at a high pressure substantially higher than atmospheric pressure, generally between 1.6 and 8 bara, preferentially between 2 and 6 bara, and the low pressure is below atmospheric pressure, typically between 30 and 800 mbara, preferably between 100 and 600 mbara;
PSA methods in which the adsorption takes place at a high pressure appreciably higher than atmospheric pressure, typically between 1.6 and 50 bara, preferentially between 2 and 35 bara, and the low pressure is higher than or substantially equal to atmospheric pressure and therefore between 1 and 9 bara, preferably between 1.2 and 2.5 bara.

Hereinafter the term “RPSA method” will be used to designate PSA methods with a very rapid cycle, in general less than 1 minute.

In general terms, a PSA method makes it possible to separate one or more gas molecules from a gaseous mixture containing them, by exploiting the difference in affinity of a given adsorbent or, where applicable, of several adsorbents for these various gas molecules.

The affinity of an adsorbent for a gaseous molecule depends on the structure and composition of the adsorbent, as well the properties of the molecule, in particular its size, electron structure and multipole moments.

An adsorbent may for example be a zeolite, an active carbon, an activated alumina, a silica gel, a carbonaceous or otherwise molecular sieve, a metallo-organic structure, one or more oxides or hydroxides of alkali or alkaline-earth metals, or a porous structure containing a substance capable of reacting reversibly with one or more gas molecules, such as amines, physical solvents, metal complexing agents, or metal oxides or hydroxides for example.

Adsorption is an exothermic phenomenon, each molecule-adsorbent pair being characterised by an adsorption enthalpy (isosteric heat) or a reaction enthalpy in general.

Symmetrically, desorption is endothermic.

Moreover, a PSA method is a cyclic method comprising several sequential adsorption and desorption steps.

Consequently some steps in the cycle of a PSA are exothermic, in particular the step of adsorption of the gas molecules adsorbed on the adsorbent, whereas other steps are endothermic, in particular the step of regeneration or desorption of the molecules adsorbed on the adsorbent.

The thermal effects that result from the adsorption enthalpy or the reaction enthalpy lead, in general terms, to the propagation, at each cycle, of a heat wave on adsorption limiting the adsorption capacities and a cold wave on desorption limiting desorption.

This local cyclic phenomenon of temperatures changes has not insignificant impact on the separation performances of the method, such as productivity, separation efficiency and the specific separation energy, as stated by the document EP-A-1188470.

Thus it has been shown that, if the thermal changes due to adsorption enthalpy were completely eradicated, the productivity of certain current industrial O₂ PSAs would be improved by around 50% and the oxygen yield would be improved by 10%. Likewise, for other types of PSA, attenuating the thermal changes would give rise to an appreciable improvement in the separation performances.

This negative phenomenon having been identified, several solutions have already been described for attempting to decrease or eliminate it.

Thus it has been proposed to increase the heat capacity of the adsorbent medium by adding an inert binder, when the particles are manufactured, by depositing the adsorbent medium on an inert core, by adding particles that are identical to the adsorbent but inert. For example, in the case of an O₂ PSA method, effecting the adsorption of the nitrogen contained in air on a composite bed consisting of 5A and 3A zeolites differentiated from each other only by the size of their pores has already been tested: only those of 5A zeolite enable nitrogen to be adsorbed since those of 3A zeolite are too small.

Moreover, the use of external heating and/or cooling means for counterbalancing the thermal effects of the desorption or adsorption, such as the use of heat exchangers, has also been described.

Thermal couplings between adsorption phase and regeneration phase have also been proposed, the adsorbent being disposed in the successive passages of a plate exchanger, the circulation of fluids then being organised so that the passages are alternatively in adsorption phase and desorption phase.

Another solution for reducing the amplitude of the thermal changes consists of adding to the adsorbent bed a phase-change material (PCM), as described by the document U.S. Pat. No. 4,971,605. In this way, the adsorption and desorption heat, or some of this heat, is absorbed in the form of latent heat by the PCM, at the temperature, or in the range of temperatures, of the phase change of the PCM. It is then possible to operate the PCA unit in a mode closer to isothermal conditions.

In practice, phase change materials (PCMs) act as heat sinks at their phase-change temperature, or over their phase-change temperature range lying between a lower and higher phase-change temperature.

In order to be able to handle them, whether they be in the solid or liquid state, PCMs are in practice generally microencapsulated in a micronic solid shell, preferably based on polymers (melamine formaldehyde, acrylic, etc.).

Microencapsulated PCMs, available in powder form, cannot be introduced as they stand into an adsorbent bed since they would be entrained by the gas flows circulating in the adsorber.

The document WO 2008/037904 describes a method of the PSA type using a bed comprising adsorbent particles and particles of a phase-change material (PCM) in the form of agglomerates with a density different from that of the adsorbent but complying with the stability criteria of the mixture based on the ratio on the one hand of the densities and on the other hand of the diameters of the PCM agglomerates and the adsorbent particles in the composite bed.

One of the solutions that appears to be necessary for improving the thermics of PSA units and consequently their performances is therefore to produce mixtures of adsorbent and agglomerate of PCM with relatively close size and density in order to avoid or limit the problems of segregation.

However, one problem that is posed is providing a mixture of adsorbent and PCM particles preserving physical properties and in particular mechanical properties compatible with industrial use in various types of adsorbers such as for example cylindrical adsorbers with a vertical or horizontal axis, or radial adsorbers; and for the various applications envisaged.

This is because, in particular, in order to avoid problems of the creation of dust, particle debris, local settling, etc., the mixture must have sufficient characteristics in terms of resistance to crushing, resistance to attrition and elasticity.

For the adsorbent itself, these properties generally form part of the particular specifications defining its physical characteristics.

A resistance to crushing value and a value characteristic of the resistance to erosion by friction are typically found. The corresponding test methods are either standardised or particular to each supplier.

For example, resistance to crushing may be measured ball by ball or in a bed. The number of balls, the prior sieving of the balls, their residual water content, the way of increasing the pressure applied—for example the speed—must be defined in order to have reliable and repeatable measurements.

Resistance to attrition generally consists of measuring the percentage by weight of dust created after having subjected a certain quantity of adsorbent to a clearly defined treatment. There also, all the parameters must be defined in order to obtain useful measurements.

It is not necessary here to go into any detail in all the existing procedures for measuring certain mechanical properties or to list the values of these properties for all adsorbents but just to show that these mechanical properties form part of the basic characteristics of the adsorbents and that minimum values (for example resistance to crushing) or maximum values (for example creation of dust by attrition) are required for using the adsorbents effectively and safely.

It is therefore necessary to produce MCP particles having mechanical properties at a minimum close to those of the adsorbents so that these particles are not the weak link in the mixture by breaking or eroding.

It should be noted that, in the context of the present invention, the “diameter” means the equivalent diameter of the PCA particle. The “equivalent diameter” of a particle is that of the sphere having the same specific surface, this specific surface being the surface compared with the volume of the particle in question.

Thus, for a rod of diameter d and length l, the equivalent diameter De is obtained such that: De=6.1.d/(2.d+4.1)

For a pellet such that d=1, the equivalent diameter is the diameter of the particle.

In general terms, for the majority of geometries of the particles used of a cylindrical type, an equivalent diameter is found lying between 0.75 and 1.3 times the diameter of the cylinder.

For a spheroid ball, the equivalent diameter is directly the diameter of the ball.

For a population of balls that are essentially spherical but the diameters of which have a dispersion inherent in the industrial manufacturing method, a conventional definition is adopted: the equivalent diameter of a population of balls is the diameter of identical balls which, for the same bed volume, would give the same total surface area. This is because, as soon as the diameter distribution has determined (that is to say the various fractions Xi of diameter Di have been determined, with preferably i greater than or equal to 5 in order to obtain sufficient precision, for example by sieving or from image processing apparatus), the equivalent diameter is obtained by the formula: 1/De=Σi(Xi/Di)

For crushed adsorbents, a form in which some activated carbons can in particular be found, the particles are assimilated to spheres, the diameter distribution of which is determined by sieving, and then the above calculation formula is applied.

One solution of the invention is a PCM particle consisting of an agglomerate comprising a phase change material (PCM) and a coating layer with a composition different to that of the agglomerate.

Thus the solution consists only of modifying the surface of the agglomerate in order to increase the mechanical properties thereof, that is to say modify the composition or distribution of the constituents used during the formation of the particle a little before obtaining the required size. In this way the agglomerate is coated with a layer having different mechanical properties improving overall the mechanical strength of the PCM particle: resistance to crushing, attrition, and elasticity.

It appears that this coating could also have other beneficial functions such as improving the impermeability to fluid of the particle, which can be made non-porous, resistance to chemical attacks, heat transfer, etc.

It should be noted that this coating method is not applicable to the adsorbent since, in its case, the transfer of the molecules of the fluid to the active sites of the adsorbent is preponderant and any additional resistance to this transfer would be prejudicial or even catastrophic if tending towards an impervious barrier.

Coating of the PCM particles can be envisaged here only because the adsorption functions (the particle of adsorbent) have been physically separated from the heat-sink function (the PCM particle).

FIG. 1 shows a PCM particle 1 according to the invention consisting of an agglomerate of microcapsules of PCM 2—optionally agglomerated by a binder 3—and coated with a coating layer 4.

One advantage procured by a coating layer is that, in the event of accidental release of microcapsules of PCM from the aggregate, they are retained inside the coating layer and there is no risk of their being swept away by the fluid.

In extreme cases, this makes it possible to limit the quantity of binder to the minimum in order to ensure cohesion of the agglomerate during manufacture thereof, thus making it possible to obtain a particle very rich in PCM and therefore with a high thermal performance. The mechanical properties, in particular of resistance to attrition, are then essentially due to the presence of the coating layer which in this case has the role of a shell.

According to circumstances, the PCM particle according to the invention may have one or more of the following features:
the thickness of the coating layer represents between 0.001% and 10% of the diameter of the particle, preferably between 0.01% and 1% of the diameter of the particle; it should be noted that the thickness of the coating is a compromise between the amplitude of the modifications of the mechanical or thermal properties that are sought and the useful volume of microcapsules of PCM, that is to say in practice the volume quantity of heat available during the phase change. The thickness will also depend on the deposition method used. The nature of the deposition may be varied. It will depend essentially on the improvements that are sought;
the coating layer comprises an organic or inorganic material; an organic coating will for example improve the resistance to attrition and the elasticity whereas an inorganic coating will promote thermal conduction and hardness;
the organic or inorganic material content is greater than the organic or inorganic material content of the agglomerate.
the organic material is at least one polymer; the volume percentage of the at least one polymer in the coating layer is preferentially greater than 50% and may be as much as 100%. A coating layer completely made from polymer may make the PCM particle completely gastight and in doing this tend to improve the performances of the adsorption unit that would use such PCM particles (by reducing the gaseous volume in the bed of adsorbent/PCM). The polymer is preferably polyurethane and/or polycarbonate. These polymers constitute in fact one of the basic solutions for producing the envelope and more particularly polyurethane because of its low cost and its physical properties;
the coating layer comprises solid particles with thermal conductivity greater than 0.5 W/m/K; the coating layer preferably comprises by volume between 0% and 50% solid particles, more preferentially between 0% and 15% solid particles;
the coating layer comprises at least 0.5% polymer and is impervious;
the inorganic material is a metal compound, a metal or a metal alloy; nitrides, oxides or metal carbides, or metal alloys as well as pure metals, can be used. A ferromagnetic character different from that of the adsorbent particles may allow magnetic separation of the PCM particles and the adsorbent;
the proportion of phase change material in the coating layer is less than the proportion of phase change material in the agglomerate;
the coating layer comprises graphite rods;
the phase change material is chosen from paraffin, fatty acids, hydrogenous compounds, oxygenated compounds, phenyls and hydrated salts or a mixture of these compounds.

It should be noted that, unless otherwise stipulated, when the diameter of a population of particles (PCM agglomerates, adsorbent) are mentioned, this means the “mean equivalent diameter”.

The thickness of the coating layer obviously varies locally for a given particle but also from particle to particle.

The thickness of the layer means the mean thickness that can be measured from a sample of particles open in their centre. FIG. 8 shows a sample of four half-balls corresponding to a random sample of four particles.

The ratio can be defined as the mean of the eight thicknesses EP measured along the axis AA to the mean of the four diameters D measured along the axis.

If it is sought to define this ratio more precisely, a larger number of particles (say 25) can be used.

In practice, in order to define the mean thickness of the protective layer, the diameter of a sample of non-coated agglomerates and the diameter of a second sample of the same coated population (same manufacturer) are measured. The difference in the diameters easily gives the thickness of the coating.

Note that the heat absorption capacity of a PCM is all the greater, the higher its latent heat. Generally PCMs are used for their solid-liquid phase change.

In order to be able to handle them, whether they be in the solid or liquid state, PCMs are in practice generally microencapsulated in a micronic solid shell, preferably based on polymers (melamine formaldehyde, acrylic, etc.).

Since paraffins are in particular relatively easy to microencapsulate, they are generally PCMs of choice compared with hydrated salts, even if paraffins have a latent heat generally less than that of hydrated salts.

In addition, paraffins have other advantages such as reversibility of phase change, chemical stability, defined phase change temperature or defined lower and upper phase change temperatures (that is to say there is no hysteresis effect), low cost, low toxicity and wide choice of phase change temperatures according to the number of carbon atoms and the structure of the molecule.

Microencapsulated paraffinic PCMs are in the form of a powder, each microcapsule constituting this power having a diameter of between 50 nm and 100 μm, preferentially between 0.2 and 50 μm. Each microcapsule has a thermal conductivity of around 0.1 to 0.2 W/m/K, depending on whether the paraffin is in the solid or liquid state inside the microcapsule.

Microencapsulated PCMs available in powder form cannot be introduced into an adsorbent bed as they stand since they would be entrained by the gas flow circulating in the adsorber.

In the context of the invention, these microcapsules are therefore agglomerated. Microcapsule agglomerate means a solid with a dimension greater than 0.1 mm manufactured according to one of the known powder agglomeration techniques (granulation, extrusion, atomisation, fluidised bed, etc.) and able to adopt various forms, in particular the form of a ball, an extrusion, a pellet, a crushed piece obtained by crushing and sieving blocks of larger dimensions, or plate obtained by cutting previously compacted sheets, or others.

The agglomerate of PCM microcapsules is formed by a wet granulation method in a fluidised bed (spray coating) or by an extrusion method optionally followed by shaping in a fluidised bed granulation method.

The wet granulation method in a fluidised bed (spray coating) consists of the gradual coating of microcapsules by spraying a suspension containing these PCMs according to the so-called spray coating technique, on the agglomerates being formed and advantageously simultaneously dried. The particles are maintained in suspension in a hot air current while the coating suspension composed of a solvent (preferably water and PCM the concentration of which in said suspension various between 10% and 50% by weight as well as binders and if necessary surfactants) is sprayed. Passing through the coating cycle on several occasions covers the surface of the particles uniformly. The temperature and air flow as well as the spraying rate and pressure are chosen so as to form a homogeneous layer and to avoid the formation of scales. In this way a population of spheroid particles of essentially identical diameter is obtained.

Another method well suited to the agglomeration of PCM microcapsules is agglomeration by extrusion. Extrusion is a (thermo)mechanical fabrication/agglomeration method by means of which the material in powder form is compressed (mixed or not with suitable binders) and forced to pass through a die having the cross section of the agglomerated objects to be obtained. Extrusion is applied in various branches of industry, with materials such as metals, plastic materials, rubbers, composite materials, adsorbents, clay for manufacturing honeycomb bricks, and food pastes.

It is these particles obtained by these two methods or other methods enabling the agglomeration of PCM microcapsules into PCM agglomerate particles that are then coated with a final coating improving their physical properties. This coating may be performed:
either by a liquid (or wet) method in which the components of said coating are brought in the form of a solution, emulsion or dispersion containing the solvent (preferably water) as well as the compounds necessary for forming the coating, which can be obtained by polymerisation or copolymerisation or crosslinking under the effect of one or more factors among the following: increase in temperature, increase in their concentration, generation of free radicals or by chemical reaction on the surface. A dipping, spraying, coating, etc. method is spoken of:
either by a so-called dry method where the components of said coating are brought in the form of molecules in gaseous phase such as for example PVD (physical vapour deposition) or CVD (chemical vapour deposition) methods.

The methods where the coating is carried out wet can be performed
either in a fluidised bed (the deposition of a thin layer is effected by atomisation and drying of a solution on the surface of each PCM particle),
or by a chemical deposition method such as for example galvanic coating.

The methods in which the coating is carried out dry are generally performed either in a fluidised bed, or in a vacuum, or in a rotary chamber for moving PCM extrusions or particles.

In the case of coatings carried out wet, in particular in a fluidised bed, the nature of the solution used to do this final coating will depend on the property or properties that it is wished to improve as well as the nature of the PCM agglomerate that serves as a support.

The main compound of the solution may be an aqueous dispersion of polymers chosen from the following classes of polymer:
an aqueous polyurethane dispersion (PUD) which comprises an aqueous medium with dispersed acrylic polyurethane particles, comprising a reactional product obtained by the polymerisation of a pre-emulsion formed from ethylenic unsaturation polymerisable hydrophobic monomers, a crosslinking monomer and an active prepolymer of hydrogenated acrylic polyurethane, which is a reaction product obtained by the reaction of a polyol, an ethylenic unsaturation polymerisable monomer containing at least one hydroxide group and optionally a carboxylic acid group, and a polyisocyanate. Aqueous polyurethane dispersions (PUDs), either as a single component or combined with other polymers, are being used more and more in the field of coatings (paints, surfacings, inks, varnishes etc.), in particular because of legislative pressures for reducing VOC (volatile organic compound) emissions, but also because they have excellent properties that are difficult to obtain with other polymers.

The main advantages of PUDs are a great variety in the macromolecular composition and therefore a wide choice of performance characteristics: good physical properties (elasticity, elongation at break, etc.), good resistance to impacts and abrasions; low minimum film formation and glass transition temperatures, which has the consequence of being able to reduce the level of coalescents and any addition of plasticisers. Good compatibility with pigments, even metallic, good adhesion to metals and plastics, and good compatibility with other polymers, in particular acrylic polymers, can also be noted.

PUDs are essentially linear polyurethanes/ureas of high molecular weight stabilised in water and spherical particles with a diameter of less than 1 μm. The dispersibility of polyurethane in water is facilitated by the presence of ionic functions in the polymer chains. The viscosity of PUDs is fairly low (50 to 500 mPa·s), and it is sometimes necessary to add a thickener in order to obtain the required rheological properties during the step of injection into the fluidised bed of PCM during the formation of film coating each PCM particle.

The proportion of dry matter may vary from 30% for rigid products to 50% for flexible products, or even 60% for coatings on textiles. Flexible polymers are generally solvent-free whereas rigid polymers contain polar cosolvents miscible with water (such as tetrahydrofuran, dimethyl formamide or N-methyl pyrrolidone) to assist the coalescence of the particles. The end products (polymers issuing from dispersions) may combine flexible or extremely flexible polymers (used in textiles) with rigid polymers resistant to abrasion and impacts used in the design of varnishes protecting wood, metal or plastic materials. In our case one of the properties sought was the improvement in the mechanical strength of the MCP particles and the PUDs were chosen so as to maximise this property. In addition, residual isocyanate groups being rapidly consumed in the aqueous medium, PUDs are much less dangerous than their equivalents based on solvent. Finally, unlike other polymers in aqueous dispersion used in printing applications, the products obtained from PUDs do not redissolve after drying in an aqueous or alkaline environment.
An aqueous dispersion of a polymer in the group of thermosetting resins formed by resins based on phenol, urea, melamine, xylene, diallylphthalate, epoxy, aniline, furan or polyurethane;
An aqueous dispersion of a polymer in the following group of resins consisting of polystyrene, polymethyl methacrylate, cellulose acetate, polyamide, polyester, polyacrylonitrile, polycarbonate, polyphenyleneoxide, polyketone, polysulphone or polyphenylenesulfide;
An aqueous dispersion of the group of thermoplastic elastomers consisting of elastomers of the styrene type such as styrene-butadiene-styrene block copolymers or styrene-isoprene-styrene block copolymers or the hydrogenated form thereof, elastomers of the PVC, urethane, polyester or polyamide type, thermoplastic elastomers of the polybutadiene type such as 1,2-polybutadiene or trans-1,4-polybutadiene resins; chlorinated polyethylenes;
An aqueous dispersion of a polymer from the group of water-soluble polymers consisting of cellulosic polymers, polyelectrolytes, ionic polymers, acrylate polymers, acrylic acid polymers, gum arabic, polyvinyl pyrrolidone, polyvinyl alcohol, polyacrylic acid, polymethacrylic acid, sodium polyacrylate, polyacrylamide, polyethylene oxide, polyethylene glycol, polyethylene formamide, polyhydroxyether, polyvinyl oxazolidinone, methyl cellulose, ethyl cellulose, carboxymethyl cellulose, ethylhydroxyethyl cellulose, sodium polyacrylate, copolymers thereof and mixtures thereof.

It may also be a case of a solution of oligomers of polymers in a crosslinking solvent. This approach represents a disadvantage related to the generation of large quantities of VOCs (volatile organic compounds) requiring a dedicated post-treatment to the flows coming out of the fluidised bed.

Moreover, the formation of the coating may be accelerated by photocrosslinking in situ during the formation of the coating in the fluidised bed. Crosslinking reinforced by UV irradiation is a polymerisation reaction, initiated by UV radiation, that, in a fraction of a second, transforms a coated liquid film applied to a substrate into a three-dimensional solid polymer material. The typical formulation of a photocrosslinkable resin contains three basic ingredients: a photoinitiator, a monomer and oligomer, the last two being provided with reactive chemical functions. Photocrosslinking under UV is a technique that uses UV light to start the crosslinking of a liquid formulation (or of a powder) and obtaining a dry, solid and well crosslinked coating. The use of coatings crosslinkable under UV in a fluidised bed is one of the techniques that makes it possible to obtain excellent coatings of MCP particles having high performance for a relatively thin layer. The crosslinking corresponds to the formation of one or more three-dimensional lattices, by chemical or physical method. The crosslinked structures are usually prepared from linear or branched prepolymers with a low molecular mass (resulting from partial polymerisation), crosslinked under the effect of heat in the presence of a catalyst/hardener.

Photopolymerisation offers, over conventional thermal methods, particularly interesting advantages:
polymerisation is almost instantaneous, the change from the molecule to the polymer material taking place in a few tenths of a second under intense irradiation; because of this it requires only a small expenditure of energy;
crosslinking occurs only in spatially well-defined areas, those that are exposed to light radiation, which makes it possible to produce images in relief at high resolution;
the reaction can be triggered at a precise instant even in the fluidised bed and be stopped at any moment, by virtue of time control of the irradiation;
the intensity of the light source can be modulated in a very wide range, which makes it possible to control the initiation speed;
by acting on the wavelength of the light radiation and/or on the photo initiator concentration, it is possible to adjust the depth of penetration of the light and therefore the thickness of the polymer layer formed, which may vary from a few micrometres to several millimetres;
the photoinitiated polymerisations are normally carried out at ambient temperature, with resins not containing any solvent, which reduces the emission of polluting vapours;
the polymer substances fabricated by this method have technical characteristics that compare very favourably with those of film polymerisation products or the use of aqueous dispersions and the characteristics obtained show good resistance to solvents and abrasion, an excellent surface quality, a very high degree of conversion and the absence of odour.

Various crosslinking mechanisms are possible for initiating polymerisation.

The mechanism of crosslinking by radical initiation is particularly suited to acrylates, methacrylates, polyfumarates, unsaturated polyesters, polyvinyls, polycarbonates, vinyl ethers and urethanes. The mechanism of crosslinking by cationic initiation is suited to epoxy cycloaliphatics, carbohydrate ethers and epoxy/oxetane systems and vinyl ethers.

The hardness of the surface of a coating obtained by one of these wet deposition methods in a fluidised bed, measured by indentation techniques, may vary from approximately 10 N/mm² to 1000 N/mm² but it is however generally less than 500 N/mm².

As described above, this coating of the agglomerates of PCM microcapsules may be done by various coating methods: by liquid method or dry method: spraying, immersion, layering, putting in contact with vapours, in dedicated equipment (of the reactor type) or during transfer (moving belt, vibrating belt, etc.), but preferentially this coating will be carried out in a vertical fluidised bed, continuous or discontinuous.

Also preferentially, the coating step will done in the same device as the step of agglomeration of the PCM particles by modifying at the appropriate time the composition of the suspension injected into the reactor.

This is because, when the population of PCM agglomerates reaches the required dimensions (diameter), the injecting solution is modified in order to proceed with the coating step. This modification may consist of spraying only coating product without PCM microcapsules (or with a substantially lower proportion than during the previous agglomeration step, say less than 50% of the previous quantity, preferably less 10%).

It may consist of injecting a solution comprising one or more constituents different from those used previously.

Another subject matter of the present invention is a mixture of PCM particles according to the invention and adsorbent particles.

FIG. 2 shows a PCM particle manufactured according to this method and also comprising at the centre a core, for example an iron core.

The thickness of the coating layer 13 is small compared with the diameter of the particle 10 produced. In practice, the thickness of the coating will be from a few microns to a few tens of microns for particles with diameters generally between 0.5 and 5 millimetres.

The thickness to diameter ratio will range from approximately 5/5000 to 50 over 500 (in microns), that is to say from 0.1% to 10%.

FIGS. 3 to 6 show enlargements of the coating zone. FIG. 3 shows a coating 23 containing solid particles 22. These solid particles may be ferromagnetic to enable separation of PCM particles and adsorbent particles by magnetisation; they may be heat-conductive and improve the thermal transfer from the wall to the microcapsules 21; they may consist of kinds of fins on the surface of the particle in order to increase the heat transfer from the fluid to the PCMs. FIG. 4 shows the simplest coating 32. This layer may contain a certain number of PCM microcapsules still free at the start of coating. The coating of FIG. 4 may be fluidtight, in particular impervious to a gas so that the apparent porosity of the coated PCM particle may be almost zero, let us say statistically less than 5% for a bed having a large number of individuals.

The coating may actually make the agglomerate impervious to the fluid treated in the adsorber containing the adsorbent/PCM mixture.

This may directly increase the separation performances since the presence of gas in the bed of adsorbent (interstitial gas or in the macropores of the particles) has a negative effect.

This is often the case in separations by PSA for example in H₂ PSA.

FIGS. 5.a and 5.b illustrate a very thin coating 41 the purpose of which is to reinforce the adhesion of the microcapsules 40 on the surface and to limit attrition.

FIG. 6 shows a coating 50 trapping graphite rods—or filaments—52 that may penetrate the internal PCM agglomerate 51 and/or emerge to the outside.

An additional advantage of such agglomerates coated with a thin film is that the particle, because of the lesser quantity of binder—or the possibility of using other types of binder—may be more elastic than the non-covered particle.

Elastic means here that, subject to a unidirectional pressure, the shape of the particle changes without there being destruction of said particle. An initially mainly spherical particle will thus adopt the form of an ellipsoid before breaking The contact at a singular point in the case of two rigid spheres will be able to extend in such case to a substantially greater surface area.

This possibility of deforming while keeping sufficient mechanical properties may be interesting from several points of view.

The adsorbent/PCM mixture also has greater elasticity, which results in reducing the forces between particles and between particles and wall of the adsorber during operations.

The ability of coated PCM particles to deform slightly while keeping their physical integrity also makes it possible to increase the contact surface area between the particles of adsorbent and the PCM particles, thus improving the direct heat transfer by adsorbent/PCM conduction. In this case, there is a “contact surface” between adsorbent and PCM instead of the simple “contact at a singular point” between balls that are supposed to be rigid.

FIGS. 7.a and 7.b illustrate respectively the contacts of the almost singular point type between adsorbent 60 and PCM 61 in the case of rigid particles and contacts involving a not insignificant surface area between rigid adsorbent 62 and relatively elastic PCM 63.

Another subject matter of the present invention is therefore also mixtures in any proportion of coated PCM particles and adsorbent such as activated alumina, silica gel, zeolite, MOF, exchanged or doped adsorbent, “grafted” adsorbent, that is to say to which a function such as an amine function is added, etc.

Another subject matter of the present invention is an adsorption unit comprising a fixed bed or movable bed in which a mixture according to the invention is used.

According to circumstances, the adsorption unit may have one or more of the following features:
the adsorption unit comprises a fixed bed and the proportion of PCM particles is substantially constant throughout the volume of the bed;
said unit is an H₂ PSA, a CO₂ PSA, an O₂ PSA or an N₂ PSA.

It should be noted that, if the adsorption unit comprises a fixed bed, this bed may comprise one or several layers of adsorbent normally referred to a multi-bed in technical language.

The invention therefore concerns the majority of PSA methods and more particularly non-limitatively, apart from H₂, O₂, N₂, CO and CO₂ PSAs, PSAs for defractionation of syngas into at least two fractions, PSAs on natural gas intended to remove nitrogen, and PSAs used for the fractionation of hydrocarbon mixtures.

The invention can also be implemented in a method:
argon PSA as described in particular in U.S. Pat. No. 6,544,318, U.S. Pat. No. 6,432,170, U.S. Pat. No. 5,395,427 or U.S. Pat. No. 6,527,831. Ar PSA makes it possible to produce oxygen at a purity greater than 93%, by preferentially adsorbing either argon or oxygen present in an O₂-rich stream issuing for example from an O₂ PSA. Ar PSAs generally use a carbonaceous molecular sieve or a silver-exchange zeolite (U.S. Pat. No. 6,432,170),
He PSA, which makes it possible to produce helium by preferentially adsorbing the other molecules present in the feed stream;
any PSA enabling separation between an alkene and an alkane, typically ethylene/ethane or propylene/propane PSAs for example. These separations are based on a difference in adsorption kinetics of the molecules on a molecular sieve, carbonaceous or otherwise;
any PSA for the fractionation of synthesis gas (syngas);
any PSA for separating CH₄ from N₂.

1-15. (canceled)

16. A phase change material particle consisting of:
an agglomerate of microcapsules of a phase change material (PCM) agglomerated by a binder; and
a coating layer with a composition different from that of the agglomerate.

17. The phase change material particle of claim 16, wherein the thickness of the coating layer represents between 0.001% and 10% of the diameter of the particle,

18. The phase change material particle of claim 17, wherein the thickness of the coating layer represents between 0.01% and 1% of the diameter of the particle.

19. The phase change material particle of claim 16, wherein the coating layer comprises an organic or inorganic material.

20. The phase change material particle of claim 19, wherein the proportion of organic or inorganic material is greater than the proportion of organic or inorganic material in the agglomerate.

21. The phase change material particle of claim 19, wherein the organic material is at least one polymer.

22. The phase change material particle of claim 21, wherein the coating layer comprises solid particles with a thermal conductivity greater than 0.5 W/m/K.

23. The phase change material particle of claim 21, wherein the coating layer comprises at least 0.5% polymer and is impervious.

24. The phase change material particle of claim 16, wherein the inorganic material is a metallic compound, a metal or a metal alloy, or a mixture of these compounds.

25. The phase change material particle of claim 16, wherein the proportion of phase change material in the coating layer is less than the proportion of phase change material in the agglomerate.

26. The phase change material particle of claim 16, wherein the coating layer comprises graphite rods.

27. The phase change material particle of claim 16, wherein the phase change material is chosen from paraffins, fatty acids, hydrogenous compounds, oxygenated compounds, phenyls and hydrated salts or a mixture of these compounds.

28. A mixture of PCM particles as claimed in claim 16, and particles of adsorbents.

29. An adsorption unit comprising a fixed bed or a movable bed in which a mixture as claim in claim 28 is used.

30. The adsorption unit of claim 29, wherein the adsorption unit comprises a fixed bed and the proportion of PCM particles is substantially constant throughout the volume of the bed.

31. The adsorption unit of claim 29, wherein the unit is an H₂ PSA, a CO₂ PSA, an O₂ PSA or an N₂ PSA
